(19) United States
(12) Patent Application Publication
(10) Pub. No.: US 2007/0222276 A1
(43) Pub. Date: Sep. 27, 2007

(54) BALANCE FOR TIMEPIECE MOVEMENT

(75) Inventors: Marco Verardo, Les Bois (CH); Emmanuel Graf, La Chaux-de-Fonds (CH); Alexandre Fussinger, Wavre (CH)

Correspondence Address: GRIFFIN & SZIPL, PC, SUITE PH-1, 2300 NINTH STREET, SOUTH, ARLINGTON, VA, 22204, US

(73) Assignee: NIVAROX-FAR S.A., Le Locle (CH)

(21) Appl. No.: 11/690,259

(22) Filed: Mar. 23, 2007

(30) Foreign Application Priority Data
Mar. 24, 2006 (EP) 06111726.3

(51) Int. Cl. B60B 25/00

(52) U.S. Cl. 301/12.1

(57) ABSTRACT

The balance comprising a felloe (3), arms (4) connecting the felloe (3) to the balance staff and inertia blocks (11) is characterized in that the felloe (3) includes studs (7) in its inner surface, a threaded hole (9) into which said inertia blocks (11) are screwed from the inside, without passing beyond the external surface of the felloe (3), passing through said felloe (3) and said studs (7).

This application claims priority from European Patent Application No. 06111726.3 filed Mar. 24, 2006, the entire disclosure of which is incorporated herein by reference.

### BACKGROUND OF THE INVENTION

The present invention concerns a balance for a timepiece movement, comprising a felloe and arms connecting the felloe to an arbour, to be associated with a balance spring to form, in a conventional manner, the mechanical oscillator, which determines the base frequency of a timepiece, in particular, a watch.

Currently, a balance for a watch movement comprises a wheel-shaped part including the felloe (or rim), the arms and a certain arrangement of inertia blocks, which are secured to the felloe of the balance and which, by adjusting their positions, allow the unbalance and moment of inertia of the balance to be altered.

The oscillation frequency f of a sprung balance oscillator is given by the relation:

1/f=2π(I/M)^{0,5}

where I is the moment of inertia of the balance about its axis of rotation and M is the resilient couple of the balance spring, expressed in Nm/rad. The usual frequencies of watch oscillators range from 2.5 Hz to 5 Hz, by steps of 0.5 Hz so that a duration of one second corresponds to an integer number of oscillator vibrations. A movement is thus designed for a given frequency and the sprung balance assembly must have that frequency. In the above formula, it can be seen that the pertinent parameter of the balance is the moment of inertia. Since the role of the arms is very limited in the moment of inertia, the latter depends foremost upon the dimensions (diameter and cross section) and density of the felloe and the elements connected thereto.

In some cases, the designer of a timepiece movement may wish to use a balance of relatively large diameters, for example for aesthetic reasons. Increasing the diameter without changing the moment of inertia can be achieved either by decreasing the cross section of the felloe or by using a less dense material. In both cases, the balance will have less mass, which reduces friction in the bearings, and thus interference with the isochronism of the balance depending upon the positions (vertical and horizontal) of the movement. However, a felloe of reduced cross section becomes too weak, especially if it has to carry the adjusting inertia blocks.

### SUMMARY OF THE INVENTION

It is an object of the present invention to achieve a sprung balance oscillator having a larger diameter than is usual, limited at the external contour of the felloe for the same frequency, or with a higher frequency with the same dimensions as a usual oscillator, while avoiding the aforementioned drawbacks.

It is also an object of the invention to provide a balance of reduced mass in order to increase the chronometric performance of the watch to which it is fitted for a given balance inertia.

A balance according to the invention is thus characterized in that the felloe comprises studs directed inwards, a threaded hole passing through said felloe and said studs, with inertia blocks screwed into said hole from the inside, having a thread length such that the ends of said inertia blocks to not extend beyond the external surface of the felloe. The studs and the inertia blocks extend from the inner surface of the felloe and are preferably regularly distributed inside the latter. These studs can be located between the arms or in recesses provided at the junction between the arms and the felloe.

### BRIEF DESCRIPTION OF THE DRAWINGS

Other peculiarities of the invention will appear in the following description of-an embodiment of a balance for a watch movement, given by way of non-limiting example with reference to the annexed drawings, in which:

FIG. 1 is a perspective view of the balance, and

FIG. 2 is an enlarged view of an inertia block.

### DETAILED DESCRIPTION OF ONE EMBODIMENT OF THE INVENTION

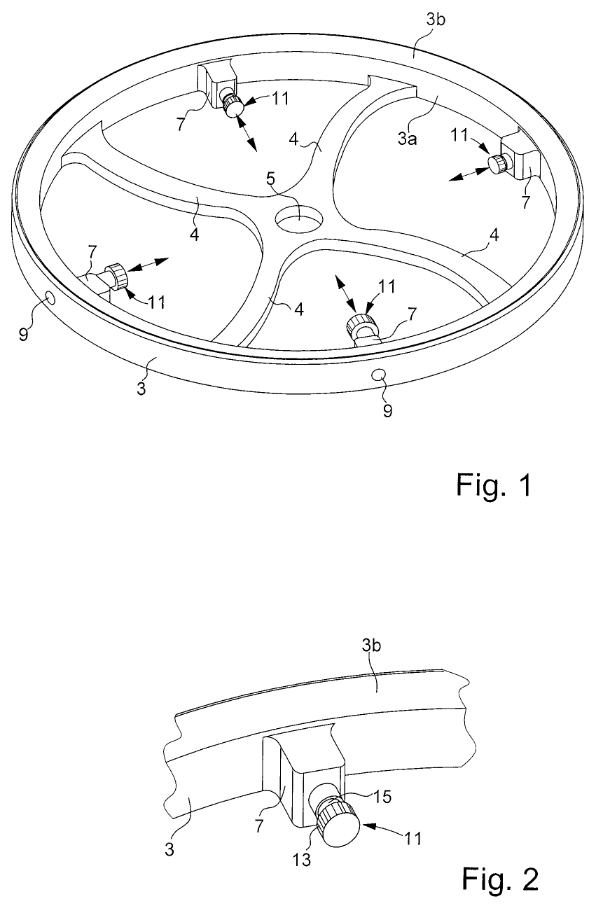

The balance 1 shown in FIGS. 1 and 2 comprises a balance wheel including a felloe 3 and for example four arms 4 integral with felloe 3. Arms 4 radiate from a central pierced part 5 which is driven onto a balance staff (not shown). As can be seen, the inner surface 3a of felloe 3 includes studs 7, which, in this example are regularly distributed between arms 4. It should be noted that any other distribution of the studs could be envisaged by those skilled in the art. These studs 7 can be integral with felloe 3, or elements that are added by any means known to those skilled in the art, for example, by welding, screws etc. If the studs are added on, one could envisage making the studs and the felloe in different materials, for example the felloe could be made of CuBe and the studs of titanium in order to further minimise the mass. A threaded hole 9 passes through felloe 3 and studs 7. Threaded holes 9 are provided for screwing in, from inside felloe 3, inertia blocks 11, whose radial movement indicated by the arrows, will enable the unbalance and moment of inertia to be adjusted. These inertia blocks 11 are formed by screws whose head preferably has a milled portion 13 facilitating handling and whose threaded stem 15 has a length such that, for a maximum moment of inertia (with the screw fully tightened) the end thereof does not pass beyond the external surface of felloe 3. According to a variant that is not shown, studs 7 can be arranged in recesses provided on the arms.

From the description that has just been given, those skilled in the art can devise multiple variants of the balance without departing from the scope of the invention defined by the claims. For example, according to a variant, studs 7 could be arranged not on the inner surface 3a of felloe 3 but on one of the two frontal surfaces 3b of the felloe, provided that they do not pass beyond the external circumference of felloe 3.

1. A Balance for a timepiece movement including a felloe, arms connecting the felloe to the balance staff and inertia blocks for adjusting the unbalance and regulating the moment of inertia, wherein the felloe includes studs directed inwards, a threaded hole into which said inertia blocks are screwed from the inside, passing through said felloe and said studs.

2. The balance according to claim 1, wherein the studs are directed radially inwards.

3. The balance according to claim 1, wherein the studs are arranged on the inner surface of the balance felloe.

4. The balance according to claim 1, wherein the studs are arranged on one of the frontal surfaces of the balance felloe.

5. The balance according to claim 1, wherein the length of the thread corresponds to the maximum travel of the inertia blocks defined by the width of the studs and the felloe, without passing beyond the exterior of the felloe.

6. The balance according to claim 1, wherein the studs are arranged between the arms.

7. The balance according to claim 1, wherein the studs are arranged in recesses provided in the arms.

8. The balance according to claim 2, wherein the studs are arranged on the inner surface of the balance felloe.

9. The balance according to claim 2, wherein the studs are arranged on one of the frontal surfaces of the balance felloe.
